(19) United States
(12) Patent Application Publication
(10) Pub. No.: US 2010/0314142 A1
(43) Pub. Date: Dec. 16, 2010

(54) Frame Orientation Control Device for an Aeration Apparatus

(76) Inventors: William Anthony Keane, Clinton (IE); Ernest Randall New, Zachary, LA (US)

Correspondence Address: JONES, WALKER, WAECHTER, POITEVENT, CARRERE;& DENEGRE, L.L.P., 5TH FLOOR, FOUR UNITED PLAZA, 8555 UNITED PLAZA BOULEVARD, BATON ROUGE, LA, 70809, US

(21) Appl. No.: 12/852,114

(22) Filed: Aug. 6, 2010

Related U.S. Application Data
(63) Continuation of application No. 12/047,087, filed on Mar. 12, 2008, now abandoned.

(30) Foreign Application Priority Data
Mar. 13, 2007 (IE) S20070164

(51) Int. Cl. A01B 45/02

(52) U.S. Cl. 172/21

(57) ABSTRACT

According to the invention, there is provided a grass treatment apparatus (an aeration device), including a support, a ground treatment implement mounted on the support, means for sensing the operating position of the ground treatment implement relative to the ground in use, means for adjusting the ground treatment implement in response to the sensed position of the ground treatment implement to maintain the ground treatment implement at a desired operating position following the contour of the ground, over which the ground treatment implement travels in use. Alternatively, the invention is an aeration device having a frame that supports reciprocating tines, and a frame orientation control for an aeration device, and includes a means for sensing or tracking the ground that is operatively connected to a means to control a ram and the associated ram.

### CROSS REFERENCE TO RELATED APPLICATIONS

This application claims the priority benefit of Irish Short Term Patent Application No. S2007/0164 filed in Ireland on Mar. 13, 2007, by Anthony Keane, for the common subject mater disclosed therein, and which is hereby incorporated by reference.

### Inventors: Anthony Keane and Ernest Randall New

### FIELD OF THE INVENTION

This invention relates to a grass treatment apparatus, in particular, for tractor pulled apparatus for golf greens and lawns using tines, and devices to adjust the depth of penetration of the tines.

### BACKGROUND OF THE INVENTION

Golf greens are compacted during use when they are walked on by players during the course of a game. To maintain the quality of such golf greens, it is necessary for ground staff to aerate the greens from time to time. This is done, for example, by aeration apparatus mounted on the three point linkage of a tractor vehicle. The apparatus has a number of tine heads which have a plurality of tines. Drive means moves the tine heads up and down (e.g. reciprocating tines), inserting the tines into the green and removing the tines to form aeration holes in the green. To assist drainage, where required, hollow tines can be used which remove plugs of earth from the green, leaving holes in the green which are back-filled with sharp sand. See for instance U.S. Pat. Nos. 6,003,613; 5,709,272; 5,667,019; 5,570,746; and 4,422,510 each hereby incorporated by reference. The U.S. Pat. No. 4,422,510 issued to de Ridder (hereinafter “de Ridder”), teaches a main frame which supports several rotary shafts, drive links, and connecting rods which reciprocate a number of pantograph-type mechanisms. In each mechanism, a tine holder having soil-piercing tines is pivotally attached to an upper link in the mechanism, and a lower link supports a spring device which allows the tines to rotate within the soil to create a drain channel. The device is typically powered by the power take-off (PTO) drive of the pulling tractor

Another device common in the industry is the “Soil Reliever”, manufactured by Southern Green, Inc. and described in U.S. Pat. Nos. 5,709,272 (the “272 patent”) and 5,570,746, both incorporated by reference in their entirety. The Soil Reliever is a tractor pulled device, PTO powered, and also has a main frame supporting a rotary shaft which drives upper links. Associated with each upper link is a lower link pivotally attached to the frame. The upper link connects to the lower link to cause the lower link to reciprocate. Pivotally attached to the distal end of the lower link is a tine holder, containing a number of removable times. Attached between the tine holder and the frame, below the lower link, is a spring member for biasing the spring against a stop positioned on the lower link.

The main frames of both the Verti-Drain device and the Soil Reliever device contain a rotatable “front” roller attached to the main frame of the aerator (for reference purposes, the “front” of the aeration devise is the PTO end, that is, the end closest to the tractor). Front roller is generally placed forward of the plane of the main frame, and hence, may be attached to the main frame with wings (as shown in FIG. 7). Front roller 10 may be vertically adjustable. Both the Verti-drain and the Soil Reliever's main frame are connected to the tractor through a three point pick up harness positioned between the device and the tractor. The connection points generally consist of two lower attachment points on the main frame (one on each side of the frame) and a top attachment point on the main frame. Lower attachment points connect pivotally to lower harness arms (or bottom links) that connects to the tractor, and top attachment point also pivotally connects to a top link or harness arm 11 that also connects to the tractor (the arm length may be adjustable such as employing a hydraulic cylinder incorporated into the arm. The top attachment point on one particular aeration device consists of two splayed 1090 arms (see FIG. 9) and a top rail 1091. Each of the splayed arms fixedly connects at one end to the lower main frame, and at the other end to the top rail. Top rail 1091 is rigidly attached between the top of the main frame and the two splayed arms. Additionally stiffening of the top rail 1092 can be provided as shown in FIG. 9. The splayed arms diverge from the top attachment point to allow the PTO to attach there between, as shown in FIG. 7.

Hence, the three point harness is a rigid structure but is pivotally mounted at the three connection points on the device, and the three links are pivotably connected to the tractor. This three point harness system is used in conjunction with the tractor's three point hitch system to raise and lower the aerator. When lowered or deployed, the aerator's front roller contacts the ground allowing the working end (the tines) to be placed in operational contact with the ground. When lifted, the entire aerator is lifted off the ground to allow for ease transportation of the aeration between working sites or locations.

The position of the working end of the device (the tine heads) with respect to the ground has been set in the past by adjusting the length of the pulling vehicle's powered adjustment arm or top link 11. As this arm is shortened, the coupling point of the top rail to the powered adjustment arm is drawn closer to the tractor, thereby raising the tine heads upwardly. As this powered adjustment arm 11 is lengthened, the coupling point moves rearwardly, thereby rotating the tine heads downwardly, thereby lowering the tine heads. The length of the arm is adjusted using a hydraulic ram. However, the operator must control the length of this powered adjustment arm while driving the tractor, and some operators have found this difficult to accomplish both tasks, and further the operator must judge the proper positioning of the frame, a task that is not easy, resulting in inconsistent penetration of the tines, and unwanted result.

To position the tine head (and ultimately the tines) for proper entry angle in the ground, an expansive spring is provided on below each lower link, as shown in FIG. 7. Spring arm has one end pivotally connected to the tine head and the other end pivotally connected to the main frame 2. The spring operates to resist expansion and hence, draws the tine head rearwardly (obviously, a hydraulic piston or shock could be used in place of spring, or an expansive spring could be employed by positioning the spring above each lower link).

These types of apparatus operate well on relatively flat portions of the greens. However, most greens nowadays have some contouring of humps and hollows to make them more challenging for the players. As the tractor moves over a hump and starts up the slope leading to the top of the hump, the aeration apparatus, which is cantilevered outwardly from the three point linkage of the tractor, is lowered so the tines are inserted deeper than desired into the ground (see FIG. 1). Then, as the tractor moves over the top of the hump and down the other side (as shown in FIG. 2), the tines are lifted upwardly making only shallow spikes in the ground, or on steep slopes not even entering the ground. Thus, the tractor has to be driven over parts of the green that were missed in the first pass. The driver of the tractor has to adjust the apparatus and, even then, it is difficult to achieve the required consistent depth of holes required throughout the green. The present invention is directed towards overcoming these problems.

### SUMMARY OF THE INVENTION

According to the invention, there is provided a grass treatment apparatus (an aeration device), including a support, a ground treatment implement mounted on the support, means for sensing the operating position of the ground treatment implement relative to the ground in use, means for adjusting the ground treatment implement in response to the sensed position of the ground treatment implement to maintain the ground treatment implement at a desired operating position following the contour of the ground, over which the ground treatment implement travels in use. Alternatively, the invention is an aeration device having a frame that supports reciprocating tines, and a frame orientation control for an aeration device, and includes a means for sensing or tracking the ground that is operatively connected to a means to control a ram and the associated ram 24.

In one embodiment, the ground treatment implement comprises one or more tine heads mounted on the support, each tine head having one or more tines, each tine head being movable on the support in an operating position between a raised position with the tines above ground and a lowered ground-engaging position in which the tines are inserted into the ground, drive means for moving each tine head between the raised position and the lowered position, the sensing means being operable for sensing the position of the tines relative to the ground, the adjusting means being operable in response to the sensed tine position to maintain the tines at a desired operating position following the contour of the ground over which the tines are moved in use.

Conveniently, the sensing means is a ground-engaging sensor wheel mounted on the support, the sensor wheel being movable up and down relative to the support, said sensor wheel operably connected to the adjusting means for controlling the position of the ground treatment implement.

Various other sensing means such as a laser operated distance measuring device may be provided for sensing the position of the tines relative to the ground and controlling adjustment of the tines.

In another embodiment, the support is movable for adjusting the position of the ground treatment implement relative to the ground.

In another embodiment, the support is pivotable for adjusting the position of the ground treatment implement relative to the ground.

In a particularly preferred embodiment, the support is pivotable by means of a ram.

In a further embodiment, the sensor wheel is operably connected to a hydraulic valve for controlling the supply of hydraulic fluid to the ram for operating the ram.

In another embodiment, the sensor wheel is operably connected to the hydraulic valve through a linkage mounted on the support.

In another embodiment, said linkage is adjustable.

In a preferred embodiment, the support is adapted for engagement with a three point linkage of a tractor vehicle. It is, however, envisaged that the apparatus of the invention could be provided with its own carriage and independent drive means for moving the carriage over the ground.

### BRIEF DESCRIPTION OF THE DRAWINGS

The invention will be more clearly understood from the following description of some embodiments thereof, given by way of example only, with reference to the accompanying drawings, in which:

FIG. 1 is a prior art grass treatment apparatus shown in use mounted on a tractor.

FIG. 2 is a view similar to FIG. 1 showing the apparatus in another position of use.

FIG. 3 is a side elevational view of a grass treatment apparatus according to the invention shown mounted on a tractor.

FIG. 4 is a side elevational view of the grass treatment apparatus of the invention.

FIG. 5 is a rear elevational view of the grass treatment apparatus of the invention.

FIG. 6 is a plan view of the grass treatment apparatus of the invention.

FIG. 7 is a side view of another embodiment of the invention.

FIG. 8 is a cross-sectional view of the device of FIG. 7 near the lever arm.

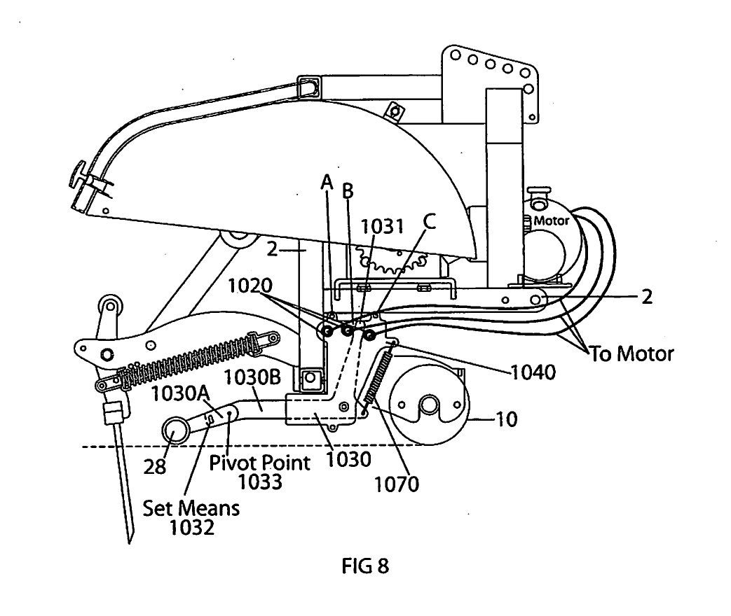

FIG. 9 is a partial prospective view of device showing the top link and piston.

FIG. 10 is a partial prospective view of device showing the top link and piston.

FIG. 11 is a depiction of the components of the hydraulic circuit.

### DETAILED DESCRIPTION OF THE INVENTION

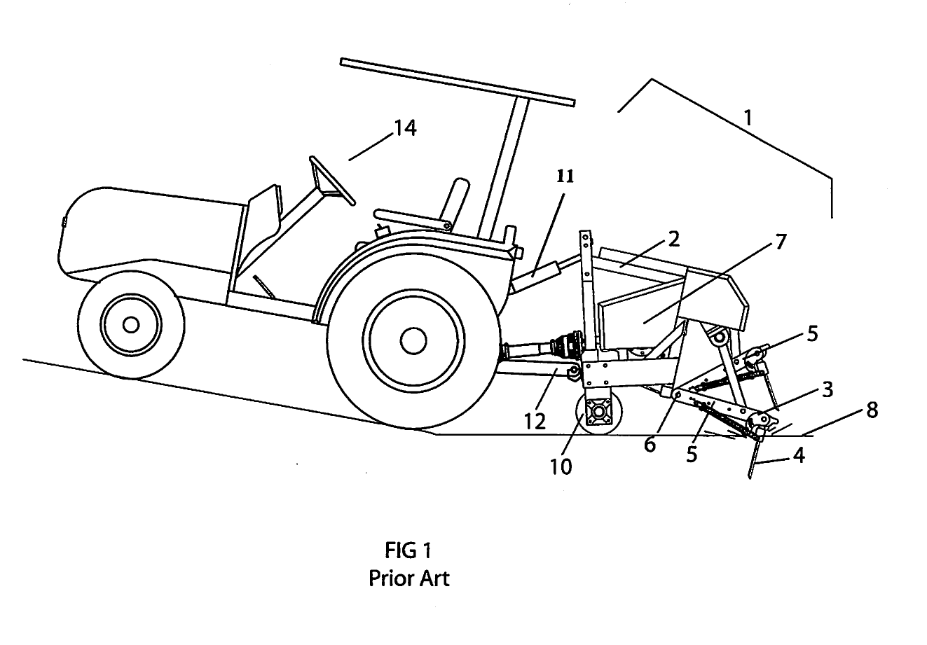

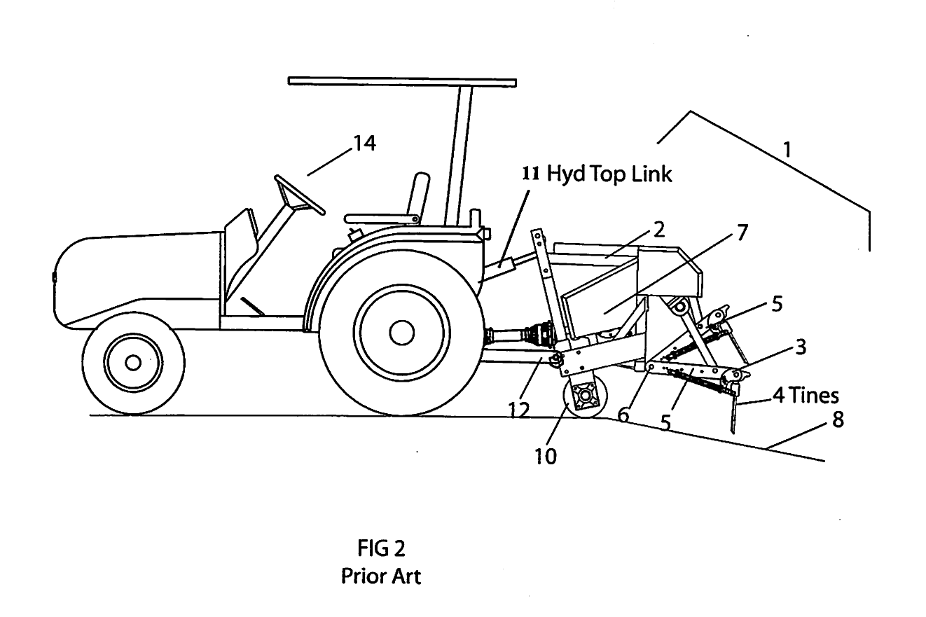

Referring to the drawings, and initially to FIGS. 1 and 2 thereof, there is shown a prior art grass treatment apparatus, indicated generally by the reference numeral 1. The grass treatment apparatus 1 has a support frame 2. A plurality of tine heads 3, each having a number of tines 4, are each mounted at an outer end of a carrier arm 5, an inner end of the carrier arm 5 being connected by a pivot 6 to the support frame 2. Drive means on the support frame 2, indicated generally by the reference numeral 7, is operable to move the arms 5 up and down for insertion of tines 4 into the ground 8 and subsequent removal of the tines 4. A roller 10 at a front end of the support frame 2 rolls over the ground. A top link 11 and bottom links 12 connect the support frame 2 to the three point linkage of a tractor 14. The power take-off of the tractor (not shown) is drivably connected to the drive means 7 for the tine heads 3. As can be seen in FIG. 1, as the tractor 14 moves up a hill, the tines 4 are lowered closer to the ground 8 and insert deeper into the ground 8. As the tractor 14 moves over the hill and down the other side, as shown in FIG. 2, the tines 4 are pivoted upwardly away from the ground 8, thus making shallower spike holes or possibly not even entering the ground 8 at all.

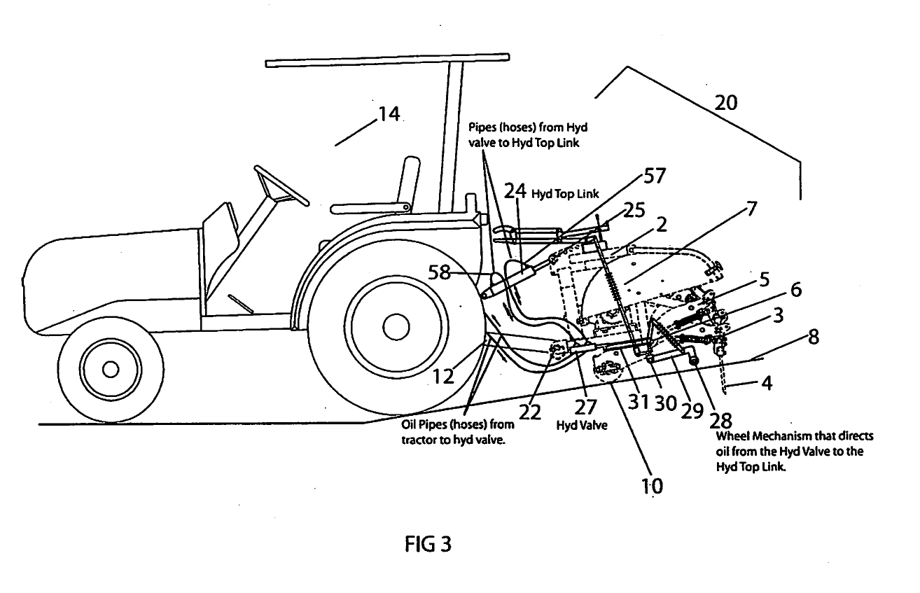

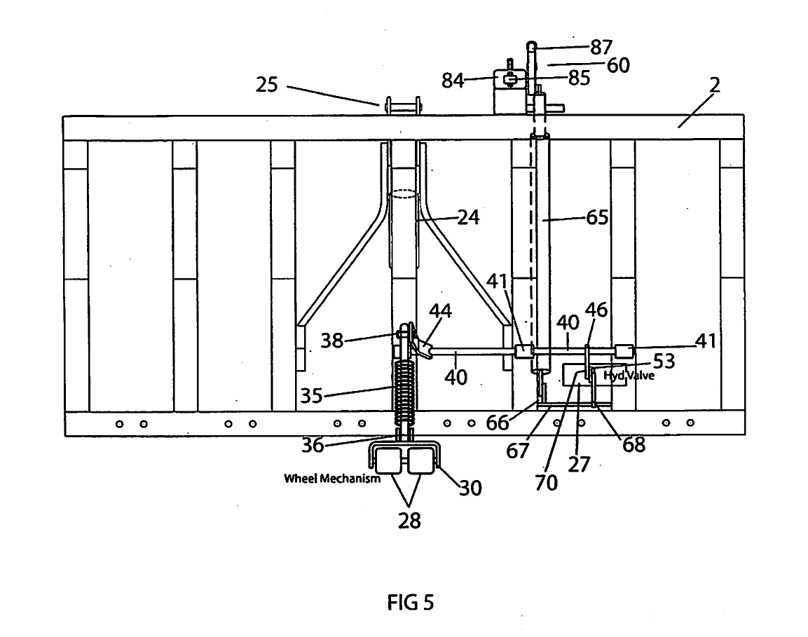

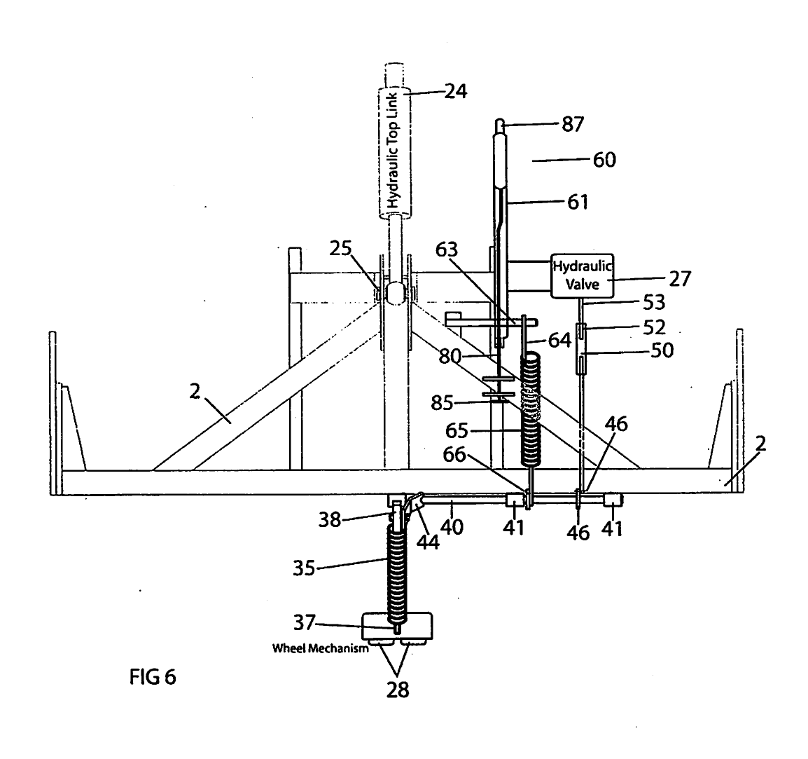

Referring now to FIGS. 3 to 6, there is illustrated a grass treatment apparatus according to the invention, indicated generally by the reference numeral 20. Parts similar to those described previously are assigned the same reference numerals. In this case, the frame 2 is pivotally mounted at 22 to the bottom links 12 of the three point linkage of the tractor 14. In this case also, the top link comprises a ram 24 having an inner end pivotally mounted to the tractor 14 and an outer end pivotally connected at 25 to a top of the support frame 2. Thus, operation of the ram 24 pivots the support frame about the pivot 22. The supply of hydraulic oil to the ram 24 for operation of the ram is controlled by a hydraulic valve 27 mounted on the support frame 2. This hydraulic valve 27 is in turn controlled by a sensor wheel 28 located immediately in front of the tines 4 and connected to the support 2 by an arm 29. An inner end of the arm 29 connects, by a pivot 30, to the support frame 2 and operates a linkage 31 which controls operation of the hydraulic valve 27. The sensor wheel 28 senses the position of the tines 4 relative to the ground 8 and adjusts the ram 24 to pivot the support frame 2 to maintain the tines 4 at a desired operating position relative to the ground following the contour of the ground 8, as the tractor 14 moves the apparatus 20 over the ground 8 to cause the tines 4 to form holes of even depth in the ground 8.

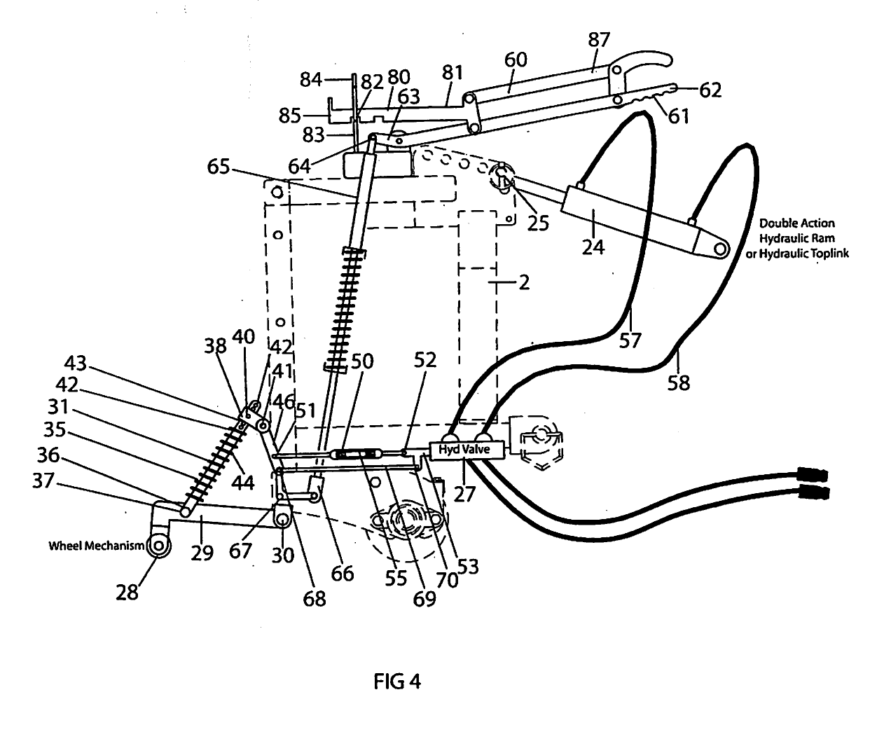

Referring in particular to FIGS. 4 to 6, the linkage 31 includes a first link 35 having an outer end 36 pivotally connected to an outer end of the arm 29 by a pivot 37. An inner end 38 of the link 35 is connected to a shaft 40 rotatably mounted in bushings 41 on the support frame 2. The inner end 38 of the link 35 is adjustable, having several holes 42 spaced-apart for engagement with a bolt 43 which connects the inner end 35 to an associated lug 44 on the shaft 40. The link 35 has a spring 44 intermediate its ends for shock absorption.

The shaft 40 has a lever 46 extending radially outwardly therefrom. A second link arm 50 connects between a pivot 51 at an outer end of the lever 46 and a pivot 52 at an outer end of an operating spindle 53 for the hydraulic valve 27. The second link 50 has a bottle screw 55 intermediate its ends for length adjustment. Thus, as the sensor wheel 28 moves up and down following the contour of the ground 8, the link 35 rotates the shaft 40 which in turn moves the lever 46 which, through the second link 50, pushes or pulls the valve spindle 53 into or out of the valve housing to operate the hydraulic valve 27 to supply hydraulic fluid through hydraulic lines 57, 58 to operate the ram 24. Thus, for the position shown in FIG. 1, the sensor wheel 28 would be pushed upwardly, thus moving the valve spindle 53 to a position which causes the ram 24 to retract, pivoting the top of the support frame 2 towards the tractor and thus raising the tines 4 away from the ground into the optimum operating position. Similarly, for the position shown in FIG. 2, the sensor wheel 28 will drop downwardly following the contour of the ground and thus, through the linkage 31, operate the valve 27 to extend the ram 24, pivoting the tines 4 downwardly towards the ground 8 into the optimum operating position to maintain the depth of holes required to be formed by the tines 4.

A hydraulic valve actuating mechanism 60 is provided at a top of the support frame 2. This comprises an actuating lever 61 having a front end 62 which can be manipulated by a driver of the tractor vehicle 14. A rear end of the arm 61 is connected to a rotatable sleeve 63 which is rotatably mounted on the support frame 2. A radial lug 64 on the sleeve 63 connects via a shock absorber 65 with a lug 66 on a shaft 67 rotatably mounted at a lower end of the support frame 2. A radial arm 68 on the shaft 67 connects through a rod 69 and bracket 70 with the spindle 53 of the hydraulic valve 27.

A locking arm 80 is pivotally mounted at 81 on the arm 61. The locking arm 80 has a pair of spaced-apart locking grooves 82, 83 which are releasably engagable with an associated receiver bracket 84 on the support frame 2 to lock the arm 61 in two separate positions of use. When the arm 61 is fully raised, the forward groove 82 locks with the receiver 84. In this position, the hydraulic valve 27 is controlled solely by the sensor wheel 28. When the arm 61 is lowered and the rearmost groove 83 engages with the receiver 84, this operates through the linkage to position the spindle 53 of the hydraulic valve 27 in a neutral position. When the arm 61 is fully lowered, a stop 85 at an outer end of the arm 80 engages with a face of the receiver 84. In this position, the hydraulic valve is moved to a position which shortens the ram 24 to lift the tines away from the ground 8 pivoting the frame to forward. This can be used, for example, at the edge of a green when turning the tractor for another pass along the green. A release mechanism 87 is operable to pivot the arm 80 upwardly for release of the grooves 82, 83 with the catch 84 to allow adjustment of the arm 80, as required.

In use, as the sensor wheel 28 travels along the ground 8, it follows the contour of the ground and as the ground falls away or rises in front of the tines, the frame 2 is pivoted by means of the ram 24 to maintain the tines 4 at a desired operating position relative to the ground so that holes of even depth are formed in the ground 8 by the tines 4.

It will be appreciated that the invention provides an apparatus for sensing the position of the tines relative to the ground and for adjusting the tines to maintain the tines at a desired operating position to form holes of a required depth in the ground evenly, even over contoured greens. The apparatus senses the contour of the green and adjusts the position of the tines appropriately.

As described, the invention is an aeration device having a frame orientation control device, where the frame orientation control device includes a means for sensing or tracking the ground (the sensor wheel 28 and arm 29) that is operatively connected (via linkage 31, lever 46 and link 50) to a means to control the orientation of a frame (here the hydraulic valve 27 and hydraulic lines to the ram 24) The ram may be associated with the aeration device, or associated with the tractor's top link. Of the three point pick up harness). The means to control the orientation of a frame controls the tilt of the frame rearwardly or forwardly. By operation of the invention, the orientation of the frame 2 of the aeration device with respect to the ground is modified without operator intervention. The invention provides for the pivot or rotation of the frame of the aeration device about a pivot point, generally the bottom link connection to the frame of the aeration device. Other embodiments of the invention are possible.

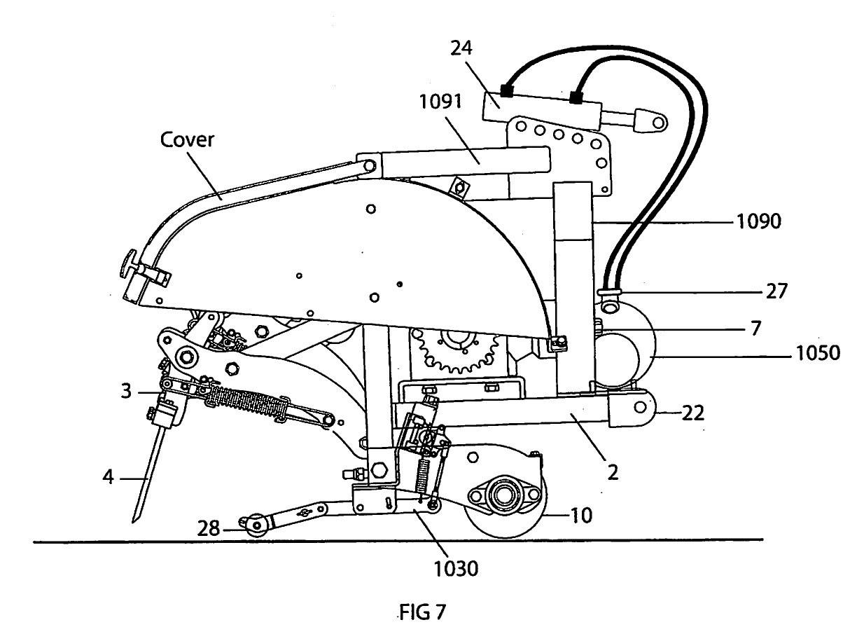

Another embodiment of the invention is shown in FIG. 7, a frame orientation control device that has an associated hydraulic valve that is driven, not by mechanical linkage, but by a hydraulic pump. The frame orientation control is shown attached to a Soil Reliever type device, however, the controller of the present invention can be used with any aeration device that has a frame and employs reciprocating tines and is pulled from a vehicle.

As shown in FIG. 7, aerator has a main frame 2. Located on the main frame 2, are a gearbox (interfacing the PTO), drive shafts, drive links, aeration mechanism, and connecting rods substantially as shown in FIG. 3 of the '272 patent, and a further description of the main device will not be repeated. Main frame 2 supports a front roller 10, and drive means (shaft) 7, and tine heads 3. Positioned on the aerator frame is lever arm 1030 and switch means 1020. As shown switch means 1020 is mounted on a plate 1040 and has three switch positions (position A, B, and C). In the embodiment shown, switch means comprises three magnetic proximity switches, one at each position A, B, and C. The switch means 1020 is mounted to the frame 2 via mount plate 1040. Pivotally attached to plate 1040 is lever arm 1030. As shown, lever arm 1030 is an “L” shaped arm consisting of lower arm 1030A and upper arm 1030B. Upper arm 1030B is pivotally connected to switch mount plate 1040, and has a distal end 1031. Other shapes for the lever arms could be used, depending on the location of the switch means 1020 and the wheel 28. Lower arm 1030B's position with respect to upper arm's 1030A position is adjustable (as shown, pivotably adjustable) but once properly adjusted and set, the combination of the two arms forms a rigid lever structure. Lower arm 1030A is pivotably connected to upper arm via pivot pin 1033, and the respective positions between the two arms can be fixed by a set means 1032, such as a bolt between the two arms. In this fashion, the desired resting position of the lever arm (the position the lever arm would assume on flat ground, that is, the location of the distal end 1031 of the lever arm with respect to the switch means) can be modified to account for different length tines. Rotatably connected to lower arm 1030A is wheel 28 (wheel could be a roller, or a ball caster type device, wheel could be replaced with a fixed plate that is slidable across the ground surface, such as a sled, etc—the lever arm and wheel (of sled) are considered a means to track the ground, as the wheel is intended to stay in contact with the ground except in pickup mode (the wheel may lose ground if it strikes an obstacle on the ground, such as an embedded rock)).

As shown, a biasing means 1070 connects the switch mount plate 1040 to the lever arm 1030A (biasing means is shown as a spring, but a hydraulic piston or shock, or large rubber band, or other biasing means could be used). Biasing means 1070 is meant to bias arm 1030 downwardly or rearwardly so that wheel 28 remains in contact with the ground. As described, as the frame 2 tilts rearwardly (tilting is about a vertical plane that is orientated about a line parallel (but rearward) to the wheel axle of the pulling tractor), lever arm 1030 rotates forwardly, (say from switch position B towards switch position C); as the frame tilts forwardly (towards the tractor), the lever arm rotates rearwardly (say from switch position C towards switch position B) as the biasing means biases the arm so that the wheel 28 remains in contact with the ground. As shown, the lever arm is positioned mid frame, but the positioning is not critical further, the position of the wheel (here shown behind the tines) is also not critical. The length of the lever arm and the distance between the switch activation points (say between A and B) can be modified for different placement of the device, or for different size aerator devices. For instance, the following wheel 28 could be placed in front of the frame 2, (assuming such placement does not interfere with the front roller) but in this instance the switch means would have to be reversed, as in this case, as the frame tilts forwardly, the lever arm also rotates forwardly. It is most preferred that the sensor wheel be close to the tine heads to accurately reflect the position of the tine heads.

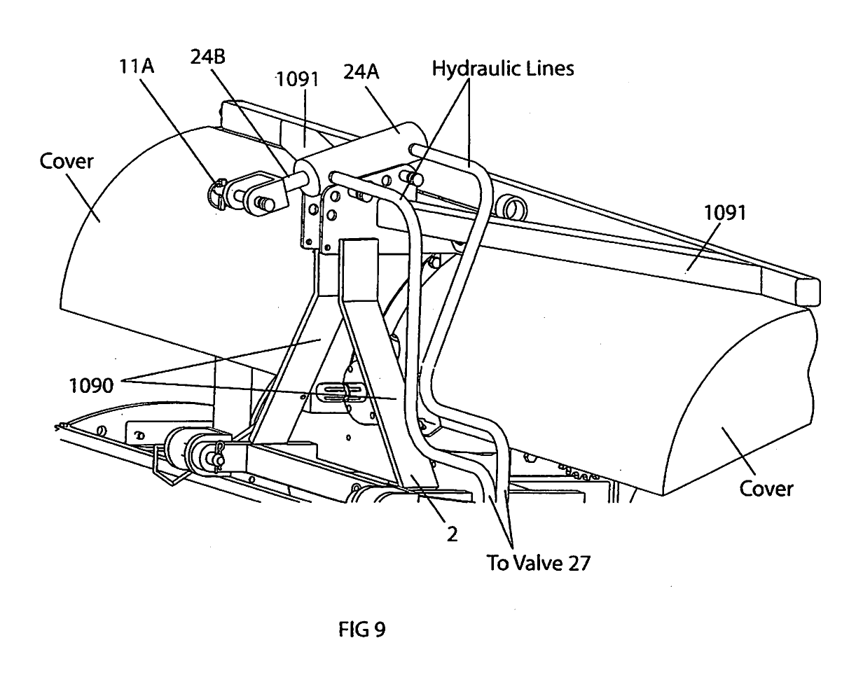

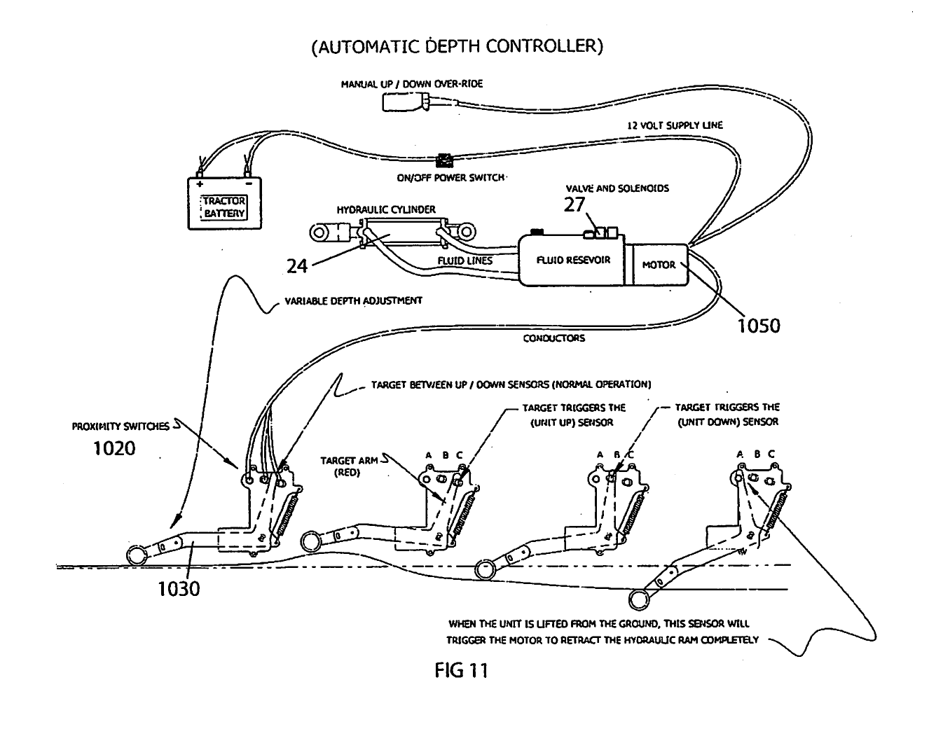

As the lever arm pivots, the distal end 1031 (here made of metal), with sufficient movement, will be sensed by the switch means. For instance, proximity switch C will be activated when the distal end 1031 of lever arm 1030 passes in front of magnetic proximity switch C, and the switch C will be deactivated when the distal end 1031 of the lever arm 1030 rotates away from the front of the switch C. Operation of switches A and B is similar. Switch means is used to switch on or off a hydraulic pump, generally mounted on the frame 2 of the device, and it activates valve 27 to direct flow through the hydraulic cylinder 24A. Hydraulic pump is operationally connected to a telescoping hydraulic ram 24 though a valve 27 (the switch means, pump (and associated motor) valve 27 and hydraulic ram 24 and the necessary hydraulic lines form a hydraulic circuit) (depicted in FIG. 11). In one embodiment (FIG. 9), the hydraulic cylinder 24A is mounted on top of the frame 2, and the top link 11 is connected to the telescoping arm or piston 24B of the hydraulic ram 24 (the piston and cylinder comprise the ram) through a shackle 11A positioned on the end of the piston 24B. The hydraulic pump 1050 and valve 27 are preferably powered by electrical power delivered from the pulling device (such as 12V DC). The hydraulic pump 1050 and associated reservoir are mounted on the frame 2 in an appropriate location. Alternatively, the hydraulic pump 1050 employed may be the pump on the pulling vehicle, however, in this event, care must be take so that the aeration device hydraulic circuit's operation does not interfere with the normal operation of the pulling vehicles hydraulic functions.

By operation of the hydraulic circuit, the piston 24B in the hydraulic ram 24 may be extended or retracted, thereby modifying the respective location of the top of the frame 2 with respect to the top link 11. Hence, the switch means 1020 controls the position of the hydraulic ram 24, which sets the rotation or orientation of the frame 2 with respect to the pulling device, and hence, the ground. The mechanism to rotate or tilt the frame with respect to the ground is considered a means to orientate the frame.

The overall operation is as follows. When the distal end 1031 of the lever arm 1030 rests between position B and C, neither switch is activated, and the hydraulic circuit remains dormant or deactivated. If the frame 2 tilts forwardly, the distal end of the lever arm rotates rearwardly, towards switch position B. When the proximity switch at position B senses the distal end 1031, it will activate the hydraulic circuit to cause the hydraulic ram 24 to lengthen (activate the pump and the valves to cause fluid to flow in the cylinder to push the ram or piston out), thereby causing the frame to rotate rearwardly. The hydraulic circuit remains active (that is, extending the piston) until the distal end 1031 of the lever arm 1030 is positioned between switch position B and C, thereby deactivating the hydraulic circuit. If the frame 2 tilts rearwardly, the distal end 1031 of the lever arm 1030 approaches switch position C, and at position C, the hydraulic circuit is activated to cause the hydraulic ram 24 to retract, thereby causing the frame 2 to rotate forwardly, and this action continues until distal end 1031 is positioned again between switches B and C. In normal operation, the distal end 1031 of the lever arm 1030 will move in response to the action of the wheel 28 between positions B and C. Position A is included to allow the device to be raised off the ground for transportation, with the result that the ram 24 is fully retracted.

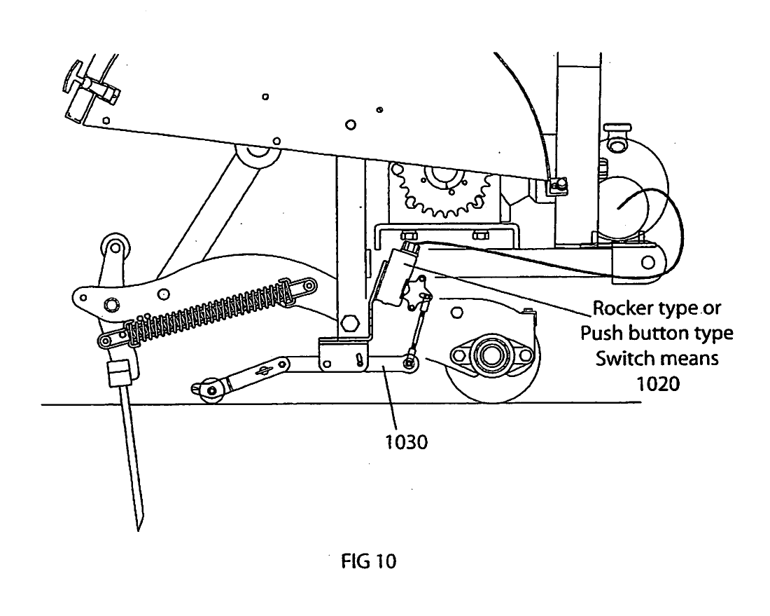

In other embodiments, the hydraulic ram may be incorporated into the top link 11 (as in the first embodiment) that connects the aerator device to the tractor. Instead of employing a hydraulic activated ram, an electrical or pneumatic driven ram may be used, such as a ram driven by a screw means operated by an electrical motor and suitable gears. Switch means may be limit switches, or other type of switches operatively connected to the wheel (or other ground sensors), such as a rocker type contact switch or pushbutton type switch 1050 shown in FIG. 10. Other embodiments may include, instead of a lever arm, a wheel mounted on a biased stem, where the stem is contained in a housing on the frame (for instance, similar to a large caster). In this instance, the position of the stem in the housing can be used to trigger switches (such as limit switches) located in the housing and these switches used to control a ram, and hence, properly orientate the frame. The invention is not limited to the embodiments hereinbefore described which may be varied in both construction and detail.

We claim:

1. An aeration device attachable to a pulling vehicle, said aeration device comprising a frame having a top portion, two side portions, and a bottom portion, and a series of reciprocating tine heads attached to said frame and a drive means to drive said reciprocating tine heads, where said frame is pivotably connectable to a pulling vehicle by a link, said link attached to said frame near said top portion and interposed between said frame and a pulling vehicle when said aeration device is attached to a pulling vehicle, said frame further having a frame wheel rotatably attached to said frame, said frame wheel adapted to contact the ground and support said frame when said aeration device is attached to a pulling device in an operating position, and a frame orientation device comprising a means for sensing the ground, said means for sensing the ground attached to said frame of said aeration device, said means for sensing the ground operatively connected to a means to control the orientation of a frame, said means to control the orientation of a device adapted to rotate said frame about a pivot point by modifying the length of said link whereby said frame wheel remains in contact with the ground when said aeration device is attached to a pulling device in a deployed position.

2. The aerator device of claim 1 wherein said means to control the orientation of a frame includes a ram, whereby operation of the ram varies the orientation of said frame with respect to said ground.

3. The aeration device of claim 2 wherein said ram is positioned on said top link.

4. The aeration device of claim 1 wherein said means to for sensing the ground comprises a wheel operationally connected to said frame.

5. The aeration device of claim 4 wherein said to a means to control the orientation of a frame is operatively connected to said wheel by a linkage.

6. The aeration device of claim 5 wherein said to a means to control the orientation of a frame includes a hydraulic ram and a hydraulic valve.

7. The aeration device of claim 6 wherein means to control the orientation of a frame includes a switch means, said switch means being operably connected to said wheel.

8. The aeration device of claim 7 wherein said switch means is operatively connected to said hydraulic valve.

9. An aeration device and a wheeled pulling device, where said aeration device comprises a frame having a top portion, two side portions, and a bottom portion, and a series of reciprocating tine heads attached to said frame and a drive means to drive said reciprocating tine heads, where said frame is pivotably connectable to said wheeled pulling vehicle by a link on said pulling vehicle, said link attached between said frame top portion and said pulling vehicle, said frame further having a frame wheel rotatably attached to said frame, said frame wheel adapted to contact the ground and support said frame when said aeration device is attached to said wheeled pulling device in a operating position, and a frame orientation device comprising a means for sensing the ground, said means for sensing the ground attached to said frame of said aeration device, said means for sensing the ground operatively connected to a means to control the orientation of a frame, said means to control the orientation of a device adapted to rotate said frame about a pivot point by modifying the length of said link whereby said frame wheel remains in contact with the ground when said aeration device is attached to a pulling device in an operating position.

10. The aeration device and pulling vehicle of claim 9 where said means to control the orientation of a frame is operationally connected to a hydraulic ram positioned on said pulling vehicle.
